(19) United States
(12) Patent Application Publication
(10) Pub. No.: US 2004/0165552 A1
(43) Pub. Date: Aug. 26, 2004

(54) Adaptive wireless transmission/reception system

(75) Inventor: In-Kyoung Kim, Seoul (KR)

Correspondence Address: FLESHNER & KIM, LLP, P.O. BOX 221200, CHANTILLY, VA, 20153, US

(73) Assignee: LG ELECTRONICS, INC.

(21) Appl. No.: 10/775,210

(22) Filed: Feb. 11, 2004

(30) Foreign Application Priority Data
Feb. 12, 2003 (KR) 8877/2003

(51) Int. Cl. H04Q 7/00; H04Q 7/28

(52) U.S. Cl. 370/329; 370/341

(57) ABSTRACT

An adaptive wireless transmitting/receiving system combines an adaptive modulation and coding (AMC) technique and a transmit diversity CFD) technique. A channel state is periodically checked and a coding technique and a modulation technique that are most suitable to the checked channel state are applied to a system, to thereby remarkably enhance a quality of a receiving signal.

### BACKGROUND OF THE INVENTION

1. Field of the Invention

The present invention relates to a wireless transmitting/receiving system and, more particularly, to a wireless transmitting/receiving system combining an adaptive modulation and coding (AMC) and a transmit diversity (TD).

2. Description of the Background Art

Recently, with the remarkable development in mobile communication and terminal technology, the low speed data transmission-centered wireless communication environment, which transmits character or voice data on the basis of a low speed transfer rate, is changing to a high-speed data transmission-centered wireless environment which enables transmission of multimedia data.

In general, a quality of a receiving signal varies depending on a distance between a base station and a terminal. In order to improve system performance, a link adaptation should be performed to adjust a transmitted signal according to a position of a user (terminal) and a channel environment. The link adaptation includes a fast power control (FPC) and an adaptive modulation and coding (AMC).

The FPC maintains a constant service quality for each terminal irrespective of the distance between the base station and each terminal by transmitting a weak signal to a terminal located close to the base station and a strong signal to a terminal located further away from the base station.

In the FPC, since a fixed modulation technique and a fixed code rate are applied to the worst channel, the transfer rate of the FPC is low. If a single antenna is used, fading occurs due to various signaling paths. The fading may cause a null state which causes a sharp deterioration of a SN (Signal-to-Noise) ratio and degradation of an average transfer rate.

In the transmission method, similar to the FPC, the modulation technique and code rate are fixed and a single antenna is used. In a wireless environment which requires a certain transfer quality, the transmission method is used. However, since the modulation technique and the code rate are fixed according to an average channel environment or the worst channel environment, the transmission method, which has a low transfer rate, is not suitable for a high speed data transmission.

The AMC is a transmission technique realizing the high-speed data transmission by improving the low transfer rate. In addition, the TD is another technique improving such a low transfer rate.

The AMC increases a transmission quantity by changing the modulation technique and the code rate according to a channel environment. In other words, when a channel environment is good, signal transmission is performed by a high order of modulation technique and a high code rate, and when the channel environment is not good, a signal is transmitted by a low order of modulation technique and a low code rate.

As a result, the AMC increases an average transmission efficiency in a cell by allowing a high-speed transmission service to be provided to a user in a good channel environment.

In employing the AMC, channel estimation is very critical. If a bad channel environment were erroneously determined to be a good channel environment due to erroneous channel estimation, the base station would perform a signal transmission at a high order of modulation technique and a high code rate which would result in a big data loss.

The transmit diversity (TD) is a diversity technique decreasing the null state while increasing the transmission quantity by using one antenna for reception while using a plurality of antennas for transmission. Namely, in the TD, the base station transmits a signal by using two or more antennas while the terminal receives a signal by using one antenna, whereby a burden of the terminal is reduced and generation of the null state is restrained.

The TD is divided into an open loop-based TD and a closed loop-based TD. The open loop-based TD refers to an STTD (Space Time Transmit Diversity), in which a signal is transmitted to some of a plurality of antennas. The closed loop-based TD refers to an STD (Selecting Transmit Diversity), in which a signal is transmitted to one antenna selected as having a good channel environment from the plurality of antennas.

The conventional wireless transmitting/receiving system will now be described with reference to the accompanying drawings.

FIG. 1 is a schematic block diagram showing the TD-based wireless transmitting/receiving system in accordance with a background art.

As shown in FIG. 1, the conventional TD-based wireless transmitting/receiving system roughly includes a transmitter 70 having a plurality of antennas and a receiver 80 having one antenna.

Referring to the transmitter 70, the transmitter 70 codes an inputted information bit by means of an encoding unit 10 and transmits it to a modulation unit 20. The modulation unit 20 modulates the coded signal.

The modulated signal is transferred to a TD-encoding unit 30, undergoes a coding process once again according to the TD technique (STTD or STD), and is wirelessly transmitted via plurality of antennas (Tx Ant1˜Tx AntN).

With the STTD, the signal coded in the TD-encoding unit 30 is wirelessly transmitted via two antennas among the plurality of antennas (Tx Ant1˜Tx AntN), and with the STD, the signal coded in the TD-encoding unit 30 is wirelessly transmitted via one of the antennas (Tx Ant1˜Tx AntN) selected as having a good channel environment.

The receiver transfers the signal collected by the reception antenna (Rx Ant) to the TD-decoding unit 40 and decodes it according to the TD (STTD or STD), and performs channel compensation. The signal processed by the TD-decoding unit 40 is transmitted to and demodulated in a demodulation unit 50, and then, transmitted to and decoded in the decoding unit 60 so as to restore to information bits.

However, with the conventional TD-based wireless transmitting/receiving system, channel estimation must be accurate to expect a certain level of performance and the system is greatly affected by the channel environment.

Although there is no difference in the structural aspect from the TD-based wireless transmitting/receiving system, the AMC-based wireless transmitting/receiving system also has a problem of losing a large amount of data if the channel estimation is not properly made.

In order to solve such shortcomings, a system adopting the two schemes (TD and AMC) has been considered, however, faces similar problems of inaccurate channel estimation and degraded performance in a bad channel environment.

### SUMMARY OF THE INVENTION

Therefore, one object of the present invention is to provide an adaptive wireless transmitting/receiving apparatus adopting both adaptive modulation coding technique and transmit diversity technique.

Another object of the present invention is to provide an adaptive wireless transmitting/receiving method capable of varying an MCS (Modulation and Coding Scheme) of a system.

To achieve at least the above objects in whole or in parts, there is provided an adaptive wireless transmitting/receiving apparatus including: an MCS setting unit for periodically checking state information of a receiving channel and setting an optimum modulation and coding scheme (MCS) level; a transmitting unit for processing information bits according to a coding technique and a modulation technique of the set MCS level, and transmitting the processed signal according to a predetermined transmit diversity (TD) technique; and a receiving unit for processing a received signal according to the MCS and TD technique which have been set by the sending side.

Preferably, the transmitting unit includes a first encoding unit for coding the information bits according to the set coding technique; a modulation unit for interleaving and modulating the coded signal according to the set modulation technique; and a second encoding unit for coding the modulation signal and transmitting the coded signal through a plurality of transmission antennas according to a predetermined transmit diversity (TD) technique.

Preferably, the modulation unit includes a channel interleaving unit for interleaving the coded signal according to the set modulation technique; a mapping unit for constellation-mapping an output signal of the channel interleaving unit according to the set modulation technique; a Walsh modulation unit for converting the mapped signal into a Walsh code block; and a scrambling unit for scrambling the converted signal.

Preferably, the receiving unit includes a first decoding unit for decoding a diversity signal collected by a reception antenna according to a predetermined TD technique and performing channel compensation; a demodulation unit for demodulating an output signal of the first decoding unit; and a second decoding unit for map-decoding the demodulated signal to restore the original information bits.

Preferably, the demodulation unit includes: a descrambling unit for descrambling an output signal of the first decoding unit; a Walsh demodulation unit for demodulating the descrambled signal; a soft determining unit for determining which symbol region the demodulated signal belongs to; and a channel deinterleaving unit for deinterleaving an output signal of the soft determining unit.

Preferably, the MCS setting unit includes: a channel information extracting unit for periodically extracting channel state information from the first decoding unit; and a selecting unit for selecting an optimum MCS with reference to the extracted channel state information.

Preferably, the channel state information is related to an SN (Signal to Noise) ratio of a channel.

To achieve at least these advantages in whole or in parts, there is further provided an adaptive wireless transmitting/receiving method including: an MCS setting step of periodically checking state information of a receiving channel and setting an optimum MCS; a transmitting step of processing information bits according to a coding technique and a modulation technique of the set MCS and transmitting the processed signal according to a predetermined transmit diversity (TD) technique; and a receiving step of processing a received signal and restoring original information bits according to the MSC and TD technique set by a sending side.

Preferably, the transmitting step includes: coding information bits according to the set coding technique; interleaving and modulating the coded signal according to a set modulation technique; coding the modulated signal and transmitting the coded signal to a plurality of transmission antennas.

Preferably, the receiving step includes: decoding a diversity signal collected by a reception antenna according to a predetermined transmit diversity (TD) technique and performing a channel compensation on the decoded signal; demodulating the compensated signal; and map-decoding the demodulated signal to restore original information bits.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is. a schematic block diagram showing a structure of a wireless transmitting/receiving system in accordance with a background art;

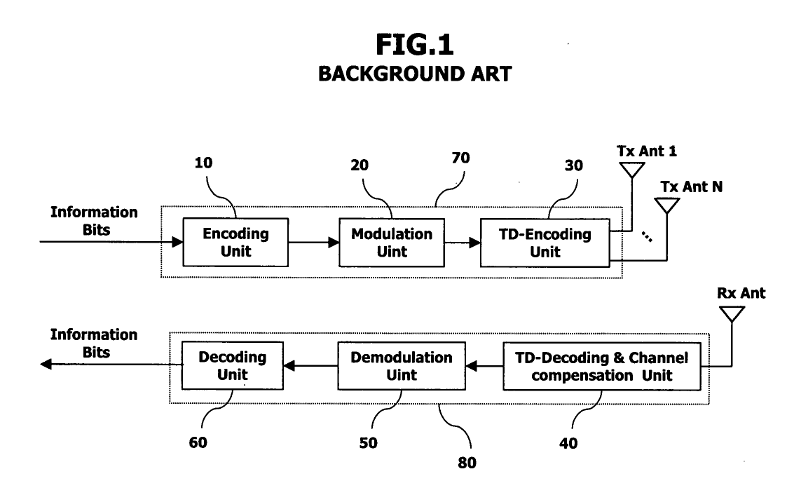

FIG. 2 illustrates a structure of a wireless transmitting/receiving system in accordance with a preferred embodiment of the present invention;

FIG. 3 illustrates a structure of a modulation unit in accordance with the preferred embodiment of the present invention; and

FIG. 4 illustrates a demodulation unit in accordance with the preferred embodiment of the present invention.

### DETAILED DESCRIPTION OF THE PREFERRED EMBODIMENTS

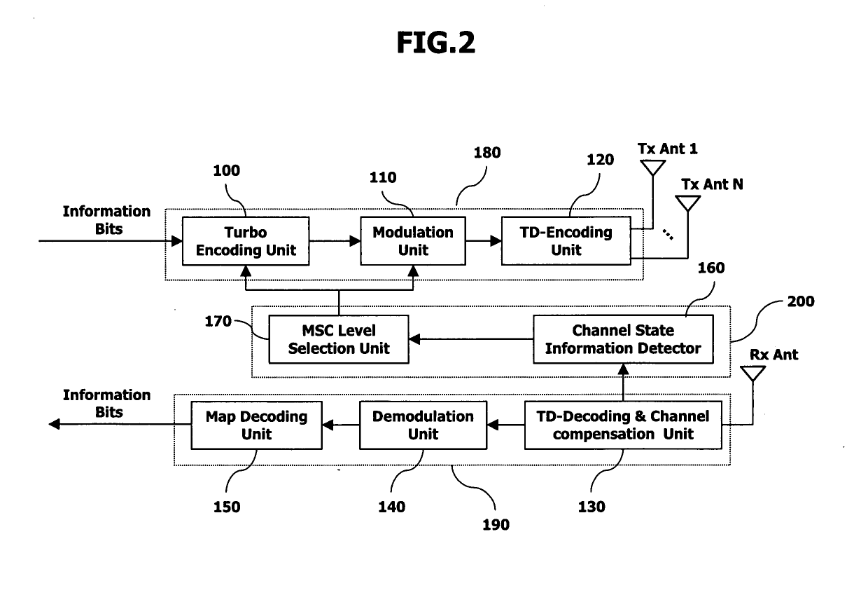

FIG. 2 illustrates a structure of a wireless transmitting/receiving system in accordance with a preferred embodiment of the present invention.

As shown in FIG. 2, the wireless transmitting/receiving system in accordance with a preferred embodiment of the present invention includes: a modulation and coding scheme (MCS) setting unit 200 for periodically checking a state information of a receiving channel and setting an optimum modulation and coding scheme (MCS) level; a transmitting unit 180 for processing information bits according to a coding technique and a modulation technique of the set MCS level and transmitting the processed signal according to a predetermined transmit diversity (TD) technique; and a receiving unit 190 for processing a received signal according to the MCS and TD technique set by a sending side and restoring original information bits.

The adaptive wireless transmitting/receiving system in accordance with the present invention checks periodically a channel state and applies MCS level that is the most suitable to a corresponding channel state to itself.

TABLE

| MCS (level) | Code (rate) | Modulation (type) | SN ratio (dB) |
|---|---|---|---|
| 1 | 1/3 | QPSK | ≦3 |
| 2 | 2/3 | QPSK | 4˜6 |
| 3 | 2/3 | 8PSK | 7˜10 |
| 4 | 2/3 | 16QAM | ≧11 |

As shown in the Table, different coding and modulation techniques are applied according to a set MCS level.

In detail, if a SN ratio of a checked channel is less than or equal to 3 dB, the MCS setting unit 200 sets the MCS level as 1 and transfers information on the MCS level to the transmitting unit 180. Then, the transnatting unit 180 applies a coding technique of a ⅓ code rate and a modulation technique of a QPSK to the system.

If the SN ratio of the checked channel is equal to or greater than or equal to 11 dB, the MCS setting unit 200 sets the MCS level as 4 and transfers information on the MCS level to the transmitting unit 180. Then, the transmitting unit 180 applies a coding technique of a ⅔ code rate and a modulation technique of a 16 QAM to the system.

In a worse channel state, the low level of MCS exhibits better performance, and in a better channel state, the high level of MCS exhibits better performance.

In general, the SN ratio applied to each MCS level is preferably a numerical value obtained through experimentation. (The SN ratios of the above Table are arbitrarily set for explanation).

The receiving unit 190 includes a TD-decoding unit 130 for decoding a diversity signal collected by a reception antenna (Rx Ant) according to a predetermined transmit diversity (TD) technique (STTD or STD) and performing a channel compensation; a demodulation unit 140 for demodulating an output signal of the TD-decoding unit 130; and a map decoding unit 150 for map-decoding the demodulated signal to restore information bits.

The demodulation unit 140 and the map-decoding unit 150 are operated corresponding to a modulation unit (or a modulation technique) and a turbo encoding unit (or a coding technique) of a transmitting side.

The MCS setting unit 200 includes a channel information-extracting unit 160 for periodically extracting channel information of the TD-decoding unit 130 and an MCS level-selecting unit 170 for selecting an optimum MCS level with reference to the extracted channel information.

The selected MCS level information is provided to the turbo encoding unit 100 and the modulation unit 110 of the transmitting unit 180. Herein, if the predetermined TD technique is the STTD, an MCS level is set for every receiving channel.

The transmitting unit 180 includes: the turbo encoding unit 100 for coding information bits according to the coding technique of the set MCS level; the modulation unit 110 for interleaving and modulating a coded output signal of the turbo encoding unit 100 according to the modulation technique of the set MCS level; and a TD-encoding unit 120 for coding an output signal of the modulation unit 110 and transmitting the coded signal through a plurality of transmission antennas (Tx Antl˜Tx AntN) according to a prescribed TD technique.

The TD-encoding unit 120 is operated differently according to the TD technique. If the TD technique is the STTD, an STTD decoder is added to the TD-encoding unit 120 to transmit a signal through several antennas. Meanwhile, if the TD technique is the STTD, the TD-encoding unit 120 selects one of the plurality of antennas, which has a good channel environment and transmits a signal to the selected antenna.

The modulation unit 110 and the demodulation unit 140 will now be described in detail.

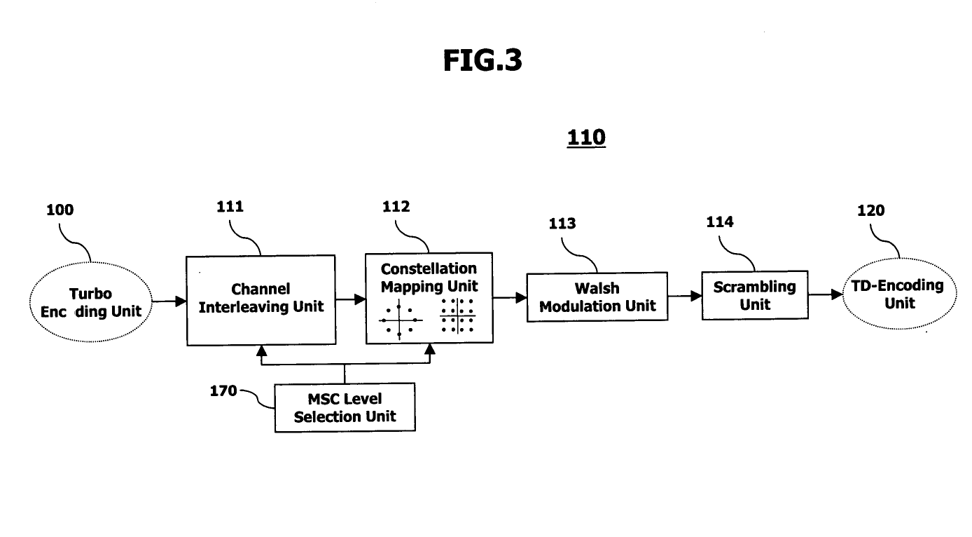

FIG. 3 illustrates a structure of the modulation unit and its interaction with the MCS level-selecting unit 170 in accordance with the preferred embodiment of the present invention.

The modulation unit 110 includes a channel interleaving unit 111 for performing an interleaving on the coded signal (that is, the output signal of the turbo encoding unit 100) according to the modulation technique of the MCS level set in consideration of an actual channel environment; a constellation mapping unit 112 for constellation-mapping an output signal of the channel interleaving unit 111 according to the modulation technique of the set MCS level; a Walsh modulation unit 113 for converting an output signal of the constellation mapping unit 112 into a Walsh code block; and a scrambling unit 114 for scrambling the converted signal.

The channel interleaving unit 111 and the constellation mapping unit 112 of the modulation unit 110 are operated according to the modulation technique of the MCS level selected by the MCS level selecting unit 170, so that an error occurrence rate is considerably reduced compared to the conventional art, and thus, a transfer rate of the overall cell can be improved.

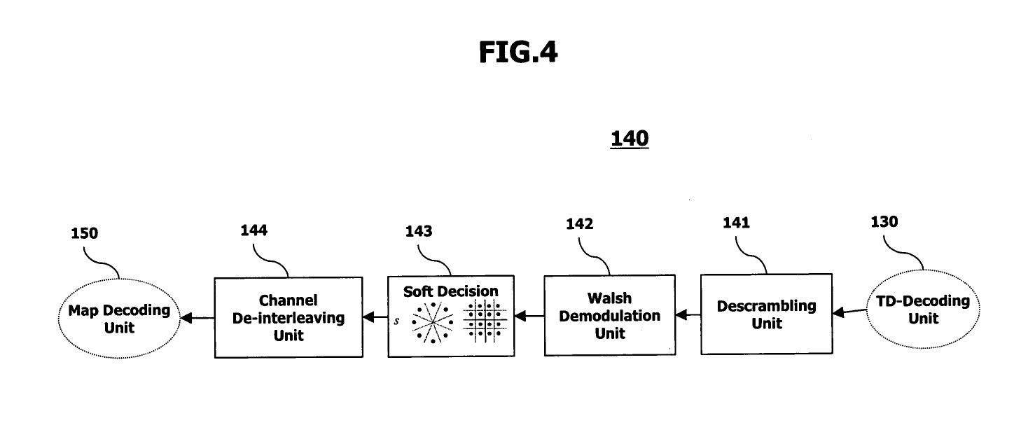

FIG. 4 illustrates the demodulation unit in accordance with the preferred embodiment of the present invention, in which the demodulation unit 140 corresponds to a modulation unit (or the modulation technique) of the transmitting side.

As shown in FIG. 4, the demodulation unit 140 includes: a descrambling unit 141 for restoring an output signal of the TD-decoding unit 130 to a pre-scrambled signal ; a Walsh demodulation unit 142 for demodulating the descrambled signal; a soft determining unit 143 for determining which symbol region an output signal of the Walsh demodulation unit 142 belongs to; and a channel deinterleaving unit 144 for restoring an output signal of the soft determining unit 143 to a pre-interleaving signal.

The demodulation unit 140 suitably demodulates a modulated signal according to a modulation technique of the transmitting side.

As so far described, the adaptive wireless transmitting/receiving system of the present invention has the following advantages.

That is, for example, by combining the adaptive modulation and coding (AMC) technique and the transmit diversity (TD) technique, the adaptive wireless transmitting/receiving system measures a channel state periodically and adopts a coding technique and a modulation technique which are most suitable to the measured channel state, thereby greatly enhancing a quality of a receiving signal.

In addition, a high transfer rate can be obtained in a multi-path channel environment in which a fading takes place frequently.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An adaptive wireless transmitting/receiving apparatus comprising:
a modulation and coding scheme (MCS) setting unit for periodically checking a state information of a receiving channel and setting an optimum modulation and coding scheme (MCS) level;
a transmitting unit for processing information bits according to a coding technique and a modulation technique of the set MCS level, and transmitting the processed signal according to a predetermined transmit diversity (TD) technique; and
a receiving unit for processing a received signal according to the MCS and TD technique, which have been set by the transmitting side.

2. The system of claim 1, wherein the transmitting unit comprises:
a first encoding unit for coding the information bits according to the set coding technique;
a modulation unit for interleaving and modulating the coded signal according to the set modulation technique; and
a second encoding unit for coding the modulation signal and transmitting the coded signal through a plurality of transmission antennas according to a predetermined transmit diversity (TD) technique.

3. The system of claim 2, wherein the modulation unit comprises:
a channel-interleaving unit for interleaving the coded signal according to the set modulation technique;
a mapping unit for constellation-mapping an output signal of the channel-interleaving unit according to the set modulation technique;
a Walsh modulation unit for converting the mapped signal into a Walsh code block; and
a scrambling unit for scrambling the converted signal.

4. The system of claim 1, wherein the predetermined transmit diversity technique is a space time transmit diversity (STTD).

5. The system of claim 4, wherein the MCS setting unit sets an optimum MCS for every receiving channel.

6. The system of claim 1, wherein the predetermined transmit diversity technique is a selecting transmit diversity (STD).

7. The system of claim 1, wherein the receiving unit comprises:
a first decoding unit for decoding a diversity signal collected by a reception antenna according to a predetermined TD technique and performing a channel compensation;
a demodulation unit for demodulating an output signal of the first decoding unit; and
a second decoding unit for map-decoding the demodulated signal to restore the original information bits.

8. The system of claim 7, wherein the demodulation unit comprises:
a descrambling unit for descrambling an output signal of the first decoding unit;
a Walsh demodulation unit for demodulating the descrambled signal;
a soft determining unit for determining which symbol region the demodulated signal belongs to; and
a channel deinterleaving unit for deinterleaving an output signal of the soft determining unit.

9. The system of claim 7, wherein the demodulation unit is operated corresponding to a modulation unit of a transmitting side.

10. The system of claim 7, wherein the second decoding unit is operated corresponding to a first encoding unit of the transmitting side.

11. The system of claim 1, wherein the MCS setting unit comprises:
a channel information extracting unit for periodically extracting channel state information from the first decoding unit; and
a selecting unit for selecting an optimum MCS with reference to the extracted channel state information.

12. The system of claim 11, wherein the selecting unit provides information on the selected MCS to the first encoding unit and to the modulation unit.

13. The system of claim 11, wherein the channel state information is about an SN (Signal to Noise) ratio of a channel.

14. An adaptive wireless transmitting/receiving method comprising:
a modulated and coding scheme (MCS) setting step of periodically checking state information of a receiving channel and setting an optimum MCS level;
a transmitting step of processing information bits according to a coding technique and a modulation technique of the set MCS and transmitting the processed signal according to a predetermined transmit diversity (TD) technique; and
a receiving step of processing a received signal and restoring original information bits according to the MSC and TD technique set by a transmitting side.

15. The method of claim 14, wherein the transmitting step comprises:
coding information bits according to the set coding technique;
interleaving and modulating the coded signal according to a set modulation technique; and
coding the modulated signal and transmitting the coded signal to a plurality of transmission antennas.

16. The method of claim 15, wherein the modulation step comprises:
interleaving the coded signal according to the set modulation technique;
constellation-mapping the interleaved signal according to the set modulation technique;
converting the mapped signal to a Walsh code block; and
scrambling the converted signal.

17. The method of claim 14, wherein the predetermined transmit diversity technique is a space time transmit diversity (STTD).

18. The method of claim 14, wherein the predetermined transmit diversity technique is a selecting transmit diversity (STD).

19. The method of claim 14, wherein the receiving step comprises:
decoding a diversity signal collected by a reception antenna according to a predetermined transmit diversity (TD) technique and performing a channel compensation on the decoded signal;
demodulating the compensated signal; and
map-decoding the demodulated signal to restore original information bits.

20. The method of claim 19, wherein the demodulation step comprises:
descrambling the compensated signal;
demodulating the descrambled signal;
determining which symbol region the demodulated signal belongs to; and
deinterleaving the determined signal.

21. The method of claim 19, wherein the demodulation step is performed corresponding to a modulation technique of a transmitting side.

22. The method of claim 19, wherein the map decoding is performed corresponding to a coding technique of the transmitting side.

23. The method of claim 14, wherein the channel state information is about an SN (Signal to Noise) ratio of a channel.
